(19) United States
(12) Patent Application Publication
(10) Pub. No.: US 2010/0215134 A1
(43) Pub. Date: Aug. 26, 2010

(54) CLOCK RECOVERY CIRCUIT AND CLOCK DATA RECOVERY CIRCUIT HAVING THE SAME

(75) Inventor: Kiyohito Sato, Kawasaki-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/607,351

(22) Filed: Oct. 28, 2009

(30) Foreign Application Priority Data
Feb. 25, 2009 (JP) 2009-042544

(51) Int. Cl. H04L 7/02

(52) U.S. Cl. 375/359

(57) ABSTRACT

A clock recovery circuit includes a frequency detection module and a correction module. The frequency detection module detects frequency offset information between a received signal and a reference clock according to a phase difference between the received signal on which timing information for reproducing the received signal is superimposed and a recovery clock. The correction module corrects a phase difference between the received signal and the recovery clock according to the frequency offset information detected by the frequency detection module.

### CROSS-REFERENCE TO RELATED APPLICATIONS

This application is based upon and claims the benefit of priority from prior Japanese Patent Application No. 2009-042544, filed Feb. 25, 2009, the entire contents of which are incorporated herein by reference.

### BACKGROUND OF THE INVENTION

1. Field of the Invention

This invention relates to a clock recovery circuit and a clock data recovery circuit having the same.

2. Description of the Related Art

In data transmission/reception via a communication line, it is necessary to read data bits at correct timings on the receiver side.

Therefore, in the conventional case, a transmission line used to transmit timing information, that is, a clock is provided in parallel with a transmission line for transmitting data. Further, when the bit rate of data to be transmitted is low, correct data is reproduced by use of the timing information.

However, it becomes necessary to increase the bit rate of data to be transmitted with an increase in the amount of information of data to be transmitted. For this reason, it becomes impossible for the clock to follow received data even if timing information is transmitted.

Therefore, a method for reproducing data by omitting the transmission line conventionally provided to transmit timing information and superimposing timing information on data is used and described in Jpn. Pat. Appln. KOKAI Publication No. 2006-80991.

### BRIEF SUMMARY OF THE INVENTION

A clock recovery circuit according to an aspect of the invention includes,

a frequency detection module which detects frequency offset information between a received signal and a reference clock according to a phase difference between the received signal on which timing information for reproducing the received signal is superimposed and a recovery clock, and

a correction module which corrects a phase difference between the received signal and the recovery clock according to the frequency offset information detected by the frequency detection module.

### BRIEF DESCRIPTION OF THE SEVERAL VIEWS OF THE DRAWING

FIG. 1 is a block diagram of a communication system according to an embodiment of this invention;

FIG. 2 is a block diagram of a clock recovery circuit according to this embodiment;

FIG. 3 is a conceptual diagram of a map according to this embodiment;

FIG. 4 is a flowchart for illustrating the operation of a clock data recovery circuit according to this embodiment;

FIG. 5 is a timing chart showing a phase difference between a received signal and a reference clock in the communication system according to this embodiment and a rise of the reference clock;

FIG. 6 is a timing chart for illustrating a case where a control unit according to this embodiment outputs gain;

FIG. 7 is a timing chart showing a phase difference between a received signal and a reference clock in the communication system according to this embodiment and a rise of the reference clock; and

FIG. 8 is a timing chart for illustrating a case where a control unit according to this embodiment outputs gain.

### DETAILED DESCRIPTION OF THE INVENTION

Embodiments of the present invention will be described below with reference to the accompanying drawings. In this explanation, common reference symbols are attached to common portions throughout the drawings; and

A clock recovery circuit and a clock data recovery circuit according to the embodiment of this invention are explained.

<Configuration of Clock Data Recovery Circuit>

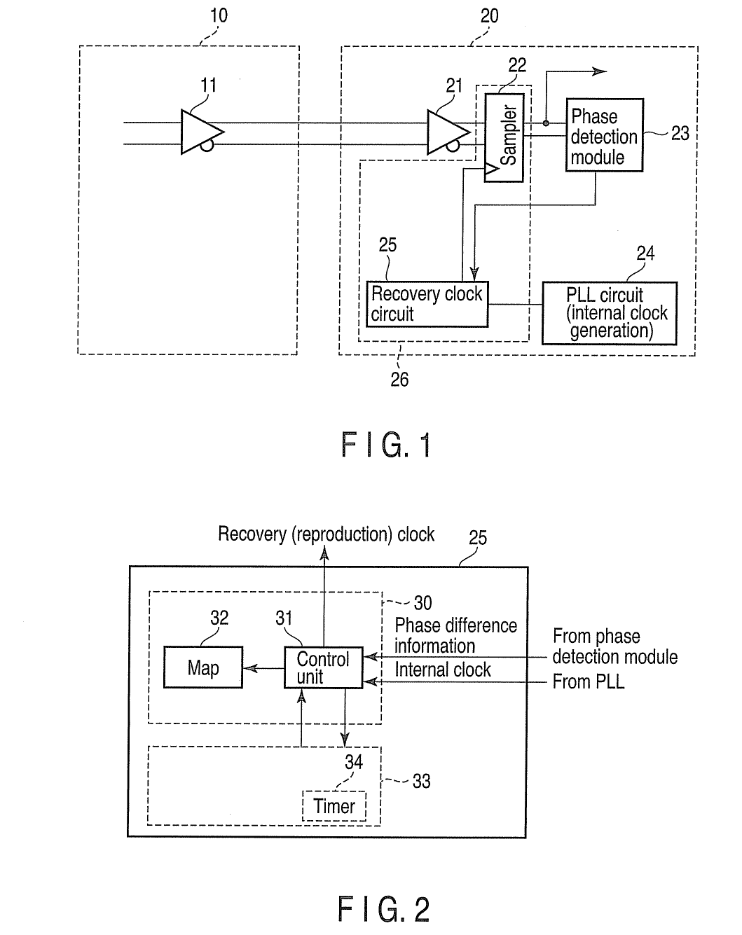

A clock data recovery circuit according to this embodiment is explained with reference to FIG. 1. A communication system including a transmitter 10 that transmits a signal and a receiver 20 that receives the above signal is shown in FIG. 1. As shown in the drawing, the transmitter 10 includes a transmission module 11 and PLL circuit (not shown).

The transmission module 11 serially transmits a signal on which timing information used to reproduce a signal on the receiver side is superimposed. Then, the PLL circuit (not shown) sets the frequency of a signal transmitted from the transmission module 11. That is, a signal is transmitted from the transmission module 11 at a frequency set by the PLL circuit (not shown). The transmitted signal is used as a serial difference signal.

The receiver 20 includes a reception module 21, sampler 22, phase detection module 23, PLL circuit 24 and clock recovery circuit 25. The reception module 21 receives a signal (hereinafter referred to as a received signal) serially transmitted from the transmitter 10 and outputs the received signal to the sampler 22.

The sampler 22 samples the received signal from the reception module 21 in synchronization with a clock (hereinafter referred to as a recovery clock) obtained by correcting the phase of an internal clock (hereinafter referred to as a reference clock) generated from the PLL circuit 24. Then, the sampler 22 outputs read data which is obtained by sampling to the phase detection module 23. The read data contains information indicating the phase relationship between the received signal and the recovery clock.

The phase detection module 23 detects a phase difference between the received signal and the recovery clock according to the above data. Then, the phase detection module 23 outputs the detected phase difference to the clock recovery circuit 25.

The PLL circuit 24 outputs a reference clock generated according to the internal frequency to the clock recovery circuit 25.

The clock recovery circuit 25 performs a phase correction process with respect to a reference clock input from the PLL circuit 24 according to the phase difference supplied from the phase detection module 23. Then, the clock recovery circuit 25 inputs a phase-corrected clock to the sampler 22 to read a precise signal with respect to the received signal (the reference clock corrected by the clock recovery circuit is hereinafter particularly referred to as the recovery [reproduction] clock). As a result, the sampler 22 reproduces timing information superimposed on a received signal to read the received signal. Further, when the phase difference is not supplied from the phase detection module 23 (for example, when phase information between a signal and a reference clock is not provided because the signal is received for the first time), the recovery clock circuit 25 outputs a reference clock to the sampler 22. The clock data recovery circuit is a general term of a circuit that reads a precise received signal by supplying a phase-corrected recovery (reproduction) clock to the sampler 22 by use of the clock recovery circuit 25 and reproducing timing information superimposed on the received signal. That is, in this embodiment, a combination of the clock recovery circuit 25 and sampler 22 is called a clock data recovery circuit 26 in FIG. 1. In this case, the combination circuit that contains the phase detection module 23 can be called a clock data recovery circuit.

<Configuration of Clock Recovery Circuit 25>

Next, the configuration of the clock recovery circuit 25 explained above is explained with reference to FIG. 2. FIG. 2 is a block diagram of the clock recovery circuit 25 according to this embodiment. As shown in the drawing, the clock recovery circuit 25 includes a phase correction module 30 and frequency detection module 33. The phase correction module 30 has a control unit 31 and map 32. The frequency detection module 33 has a timer 34. The timer 34 has a clock function, for example.

The frequency detection module 33 receives a phase difference between a received signal supplied from the phase detection module 23 and the recovery clock via the control unit 31. The frequency detection module 33 determines the magnitude of a phase difference produced between the received signal and the reference clock per unit time according to the timer 34. For example, it is assumed that the phase is shifted by 500 ps for 1 μs. That is, it is assumed that the phase is shifted by π×10⁻². Then, since the frequency of the frequency detection module 33 itself, that is, the frequency on the receiver side is previously known, the frequency detection module 33 can determine the frequency difference (hereinafter referred to as a frequency offset) between the reference clock and the received signal. Then, it outputs the frequency offset to the control unit 31. Next, the control unit 31 is explained.

The control unit 31 outputs a phase difference between the received signal input from the phase detection module 23 and the recovery clock to the frequency detection module 33. When receiving the frequency offset output from the frequency detection module 33, the control unit 31 refers to the map 32 according to the frequency offset. Subsequently, the degree of correction (hereinafter referred to as gain) of the phase of the recovery clock corresponding to the frequency offset is determined according to the map 32. Then, the phase of the reference clock input from the PLL circuit 24 is corrected according to the gain used for correcting the phase of the reference clock and the reference clock whose phase is corrected, that is, a recovery (reproduction) clock is output to the sampler 22.

The map 32 indicates the relationship between the frequency offset supplied from the frequency detection module 33 and the gain used for correcting the phase of the reference clock and corresponding to the frequency offset as data. For example, the map 32 is a semiconductor memory.

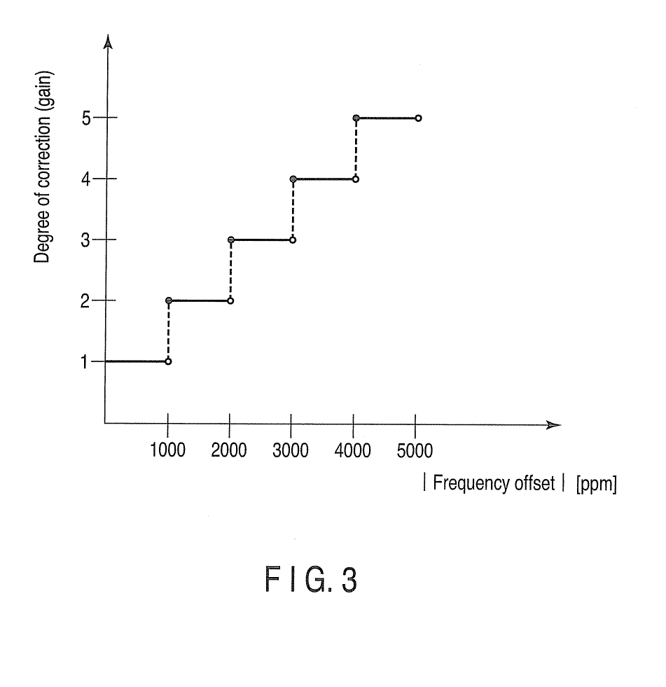

The map 32 is explained with reference to FIG. 3. FIG. 3 shows information held by the map 32 and shows the relationship between the frequency offset (expressed as an absolute value in FIG. 3) and the gain used for correcting the phase of the recovery (reproduction) clock and corresponding to the frequency offset. As shown in FIG. 3, the ordinate indicates the degree (gain) of phase correction of the recovery (reproduction) clock and the abscissa indicates the absolute value of the frequency offset. In this case, the gain indicated on the ordinate indicates a phase amount corrected at one time and, for example, when the gain is 2, the phase is corrected by an amount twice that when the gain is 1. That is, as the frequency offset becomes larger, the gain used for correcting the phase becomes higher. Further, in FIG. 3, an example is shown in which the gain used for correcting the phase when the frequency offset lies in the range of 0 to 1000 ppm is set to 1 and the gain is increased one each time the frequency offset is increased by 1000 ppm. However, it is necessary to adequately set the frequency offset used for switching the gain and the phase degree of correction per unit gain.

<Operation of Receiver 20>

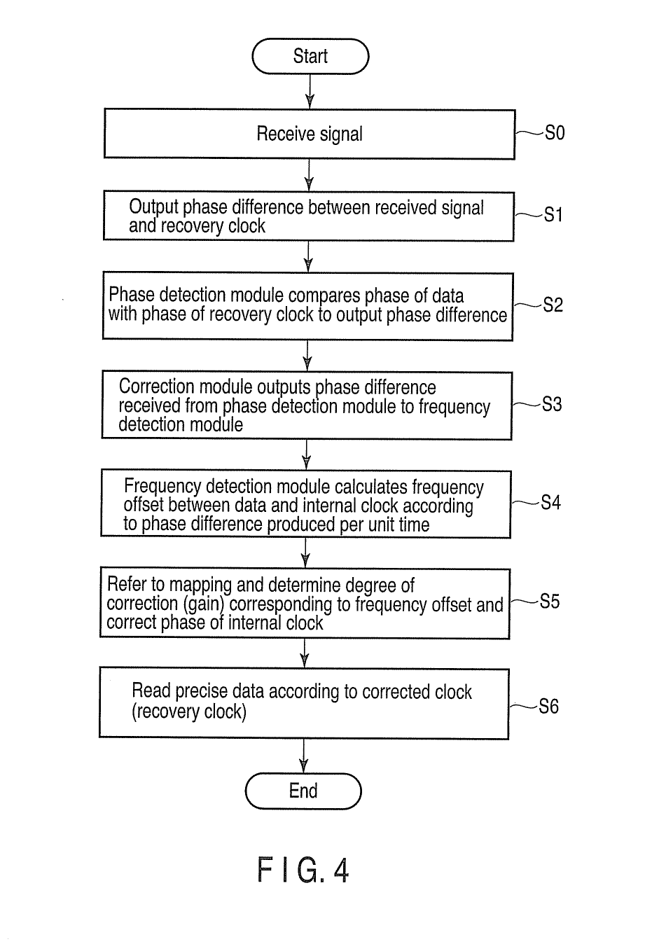

Next, the operation of the receiver 20 is explained with reference to FIG. 4. FIG. 4 is a flowchart for illustrating the operation of the receiver 20.

First, the reception module 21 receives a signal transmitted from the transmission module 11 of the transmitter 10 (step S0). Then, the reception module 21 outputs the signal to the sampler 22. The sampler 22 reads a received signal from the reception module 21 at timing at which a recovery clock is input from the clock recovery circuit 25 and outputs the read data. Further, the sampler 22 outputs the phases of the received signal and recovery clock to the phase detection module 23 (S1).

Subsequently, the phase detection module 23 compares the phase of the received signal supplied from the sampler 22 with the phase of the recovery clock and outputs the phase difference to the phase correction module 30 (S2). The phase correction module 30 outputs the phase difference to the frequency detection module 33 (S3). The frequency detection module 33 calculates a frequency offset between the received signal and the reference clock according to a phase difference produced per unit time by use of the timer 34 (S4). After this, the frequency detection module 33 outputs the calculated frequency offset to the control unit 31. Then, the control unit 31 determines the degree (gain) of phase correction of the reference clock corresponding to the frequency offset while referring to the map 32. That is, as explained with reference to FIG. 3, if a frequency offset between the received signal and the reference clock is less, the gain used for correcting the phase is set smaller and if the frequency offset is larger, the gain used for correcting the phase is set larger. Thus, the phase of the reference clock is corrected by use of the thus determined gain for correcting the phase (S5). As a result, a precise signal is read to the sampler 22 according to a reference clock synchronized with the received signal, that is, a recovery (reproduction) clock (S6).

### EFFECT OF THIS EMBODIMENT

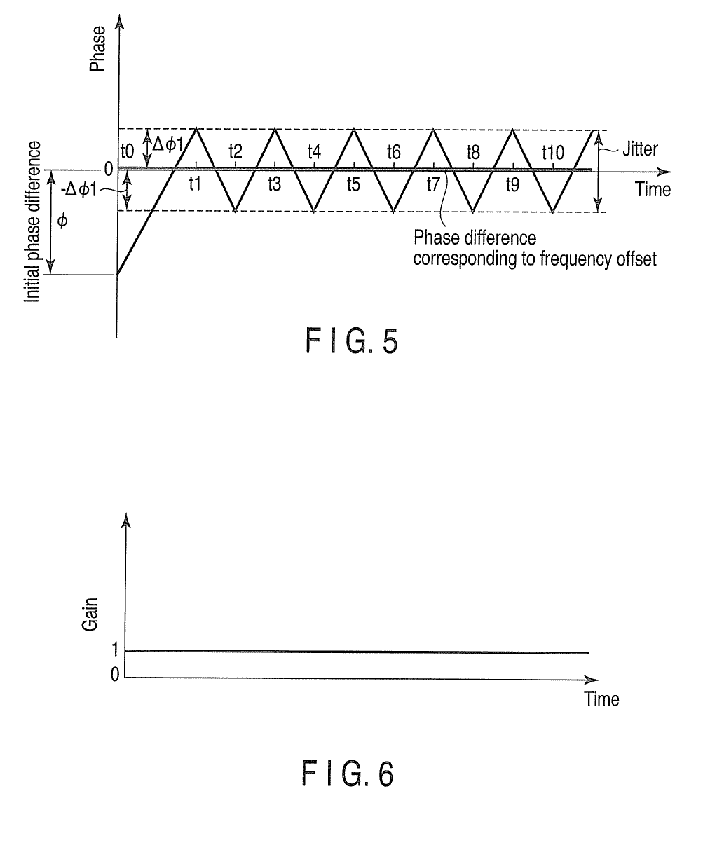

Effects 1 and 2, explained below, can be attained by use of the clock recovery circuit and the clock data recovery circuit according to this embodiment. The effects are explained with reference to FIGS. 5 to 8.

(1) An increase in the fluctuation width (hereinafter referred to as jitter) of the phase of the recovery clock can be suppressed and a received signal can be precisely read.

FIG. 5 indicates the phase of a received signal and the phase of a recovery (reproduction) clock on the ordinate and time on the abscissa and shows how to correct the phase difference between the above two signals by the clock recovery circuit 25 according to this embodiment. In this case, the recovery (reproduction) clock follows the received signal while the phase of the former lags or leads with respect to the phase of the latter. This is because fluctuation width occurs due to latency of the clock recovery circuit 25 since the clock recovery circuit 25 is designed to correct the phase after detecting the phase difference. The fluctuation width acts as jitter. Since the fluctuation width becomes larger if the gain used for correcting the phase becomes larger, the jitter varies in proportion to the gain used for correcting the phase.

As shown in FIG. 5, it is assumed that the frequency offset between the received signal and the reference clock is zero in a period t0 to t10. That is, it is assumed that the frequency of a reference clock generated by the PLL circuit 24 shown in FIG. 1 is set equal to the frequency of a signal transmitted from the transmitter 10 side according to a reference clock generated by a PLL circuit (not shown). Therefore, there occurs no difference between the phase of the received signal and the phase of the reference clock on the receiver 20 side even if time has elapsed. When the frequencies are set equal, it is assumed that a phase difference between the received signal and the reference clock on the receiver 20 side is φ at time t0.

At the operation start time (t0), the control unit 31 is operated to refer to the map 32 on the assumption that no frequency offset occurs and correct the phase of a recovery (reproduction) clock with the gain set to 1 to follow the initial phase difference φ. After the operation start time, the frequency detection module 33 starts the timer 34 and detects a frequency difference. In the example of FIG. 5, since a frequency offset between the received signal and the reference clock is zero, the frequency detection module 33 outputs the fact that the frequency offset is set in the range of 0 to 1000 ppm to the control unit 31 after the timer 34 has counted. The frequency detection module repeatedly performs the same operation each time the timer 34 has counted, but the output result is not changed from the range of 0 to 1000 ppm. Since the output of the frequency detection module 33 is kept unchanged, the control unit 31 continuously performs the operation with the gain kept at 1.

Thus, the control unit 31 always refers to the map 32 and performs the control operation to set the phase difference between the received signal and the reference clock to zero. That is, it controls the degree of the gain corresponding to the frequency offset. Therefore, if the frequency offset is smaller, jitter of the reference clock used for reading a received signal can be suppressed to the minimum value Δφ1 and the received signal can be correctly read.

The gain with which the control unit 31 corrects the phase of the reference clock in the case of FIG. 5 is explained with reference to FIG. 6. FIG. 6 is a timing chart for illustrating a gain variation with time in the case of FIG. 5. In the case of FIG. 5, since the frequency offset is zero, the gain for correcting the phase is kept unchanged and is always kept at 1. Since jitter caused by clock recovery varies in proportion to the gain for correcting the phase, it is effective to set the gain for correcting the phase to a minimum necessary value in order to suppress the jitter.

(2) Resistance to a frequency offset can be increased.

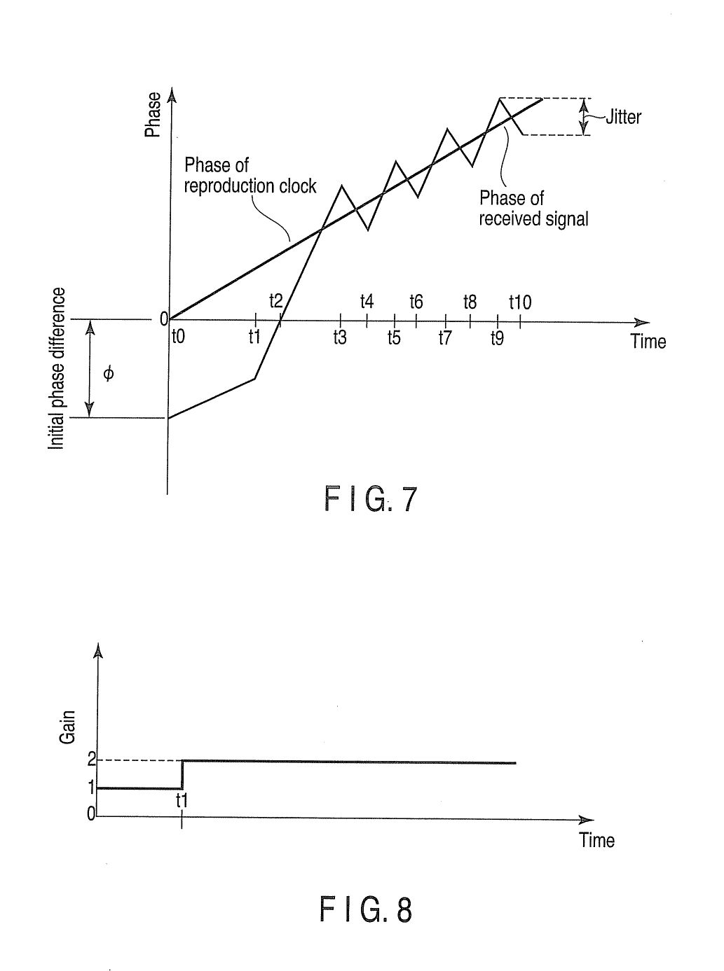

The effect is explained with reference to FIGS. 7 and 8. FIG. 7 shows a phase variation of a recovery (reproduction) clock when the gain is adjusted according to the frequency offset by causing the control unit 31 to refer to the map 32. FIG. 8 shows the state in which the gain is adjusted according to the frequency offset.

As shown in the drawing, frequency offset occurs between the received signal and the recovery clock. That is, the frequency of the reference clock generated by the PLL circuit 24 shown in FIG. 1 is different from the frequency of a signal transmitted from the transmitter 10 side. Therefore, frequency offset occurs between the received signal and the reference clock with time and the magnitude thereof becomes larger with time. In this example, a case where the frequency of the received signal is lower than that of the reference clock by 1500 ppm is shown. At this time, the phase of the received signal relatively lags the phase of the recovery (reproduction) clock.

At the operation start time (t0), the control unit 31 is operated to refer to the map 32 on the assumption that no frequency offset occurs and correct the phase of the recovery (reproduction) clock with the gain set to 1 to follow the initial phase difference φ. After the operation start time, the frequency detection module 33 starts the timer 34 and detects a frequency difference. In the example of FIG. 7, since a frequency offset (initial phase difference φ in FIG. 7) occurs between the received signal and the reference clock, the frequency detection module 33 outputs the fact that the frequency offset is set in the range of 1000 to 2000 ppm to the control unit 31 after the timer 34 has counted. The frequency detection module 33 repeatedly performs the same operation each time the timer 34 has counted, but the output result is not changed from the range of 1000 to 2000 ppm. Since the output of the frequency detection module 33 changes from the range of 0 to 1000 ppm to the range of 1000 to 2000 ppm at time t1, the control unit 31 is operated to refer to the map 32 and change the gain from 1 to 2 (FIG. 8). By thus increasing the gain (in this case, changing the gain from 1 to 2), it becomes possible to follow the frequency offset of 1500 ppm.

Thus, the gain is adjusted by the control unit 31 and the received signal can be precisely read to follow the frequency offset by increasing the gain even when the frequency offset is large. That is, resistance to the frequency offset can be increased. Further, in the map 32 shown in FIG. 3, it becomes possible to follow the received signal while the jitter of the recovery (reproduction) clock is suppressed even if the frequency offset is large by finely setting the degree of the gain corresponding to the frequency offset.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A clock recovery circuit comprising:
a frequency detection module which detects frequency offset information between a received signal on which timing information for reproducing the received signal is superimposed and a reference clock according to a phase difference between the received signal and a recovery clock, and
a correction module which corrects a phase difference between the received signal and the recovery clock according to the frequency offset information detected by the frequency detection module.

2. The circuit according to claim 1,
wherein the correction module refers to a map which indicates the frequency offset information detected by the frequency detection module and a degree of correction for correcting the phase of the recovery clock.

3. The circuit according to claim 1,
wherein the correction module corrects the phase of the recovery clock to a large extent to be synchronized with the received signal when a frequency difference between the received signal and the reference clock is large and corrects the phase of the recovery clock to a small extent to be synchronized with the received signal when a frequency difference between the received signal and the reference clock is small.

4. The circuit according to claim 2,
wherein the map is a semiconductor memory capable of holding data.

5. The circuit according to claim 1,
wherein the frequency detection module has a timer and detects the frequency offset information by determining a phase difference produced between the received signal and the reference clock per unit time according to the timer.

6. The circuit according to claim 2,
wherein the degree of correction in the map is set according to the frequency offset information.

7. The circuit according to claim 1,
wherein the correction module further includes a control unit and the control unit supplies the received signal and reference clock to the frequency detection module and refers to the map to correct the phase difference according to the frequency offset information supplied from the frequency detection module.

8. A clock data recovery circuit comprising:
a frequency detection module which detects frequency offset information between a received signal on which timing information for reproducing the received signal is superimposed and a reference clock according to a phase difference between the received signal and a recovery clock,
a correction module which controls a phase of the recovery clock to correct a phase difference between the received signal and the recovery clock while referring to a map indicating a relationship between the frequency offset information and a degree of correction according to the frequency offset information detected by the frequency detection module, and
a reproduction module which reproduces the timing information of the received signal by use of the recovery clock corrected by the correction module.

9. The circuit according to claim 8,
wherein the correction module corrects the phase of the recovery clock to a large extent to be synchronized with the received signal when a frequency difference between the received signal and the reference clock is large and corrects the phase of the recovery clock to a small extent to be synchronized with the received signal when a frequency difference between the received signal and the reference clock is small.

10. The circuit according to claim 8,
wherein the map is a semiconductor memory capable of holding data.

11. The circuit according to claim 8,
wherein the frequency detection module has a timer and detects the frequency offset information by determining a phase difference produced between the received signal and the reference clock per unit time according to the timer.

12. The circuit according to claim 8,
wherein the degree of correction in the map is set according to the frequency offset information.

13. The circuit according to claim 8,
wherein the correction module further includes a control unit and the control unit supplies the received signal and reference clock to the frequency detection module and refers to the map to correct the phase difference according to the frequency offset information supplied from the frequency detection module.

14. A clock recovery circuit comprising:
a correction module which is supplied with a phase difference between a received signal on which timing information for reproducing the received signal is superimposed and a recovery clock and frequency offset information between the received signal and a reference clock and corrects a phase of the recovery clock to acquire the timing information for reproducing the received signal according to the frequency offset information, and
a reproduction module which reproduces the timing information of the received signal by use of the recovery clock corrected by the correction module.

15. The circuit according to claim 14, further comprising a frequency detection module which detects the frequency offset information,
wherein the correction module refers to a map indicating the frequency offset information and a degree of correction by which the phase of the recovery clock is corrected to acquire the timing information.

16. The circuit according to claim 14,
wherein the correction module corrects the phase of the recovery clock to a large extent to be synchronized with the received signal when a frequency difference between the received signal and the reference clock is large and corrects the phase of the recovery clock to a small extent to be synchronized with the received signal when a frequency difference between the received signal and the reference clock is small.

17. The circuit according to claim 15,
wherein the map is a semiconductor memory capable of holding data.

18. The circuit according to claim 15,
wherein the frequency detection module has a timer and detects the frequency offset information by determining a phase difference produced between the received signal and the reference clock per unit time according to the timer.

19. The circuit according to claim 15,
wherein the correction in the map is set according to the frequency offset information.

20. The circuit according to claim 15,
wherein the correction module further includes a control unit and the control unit supplies the received signal and reference clock to the frequency detection module and refers to the map to correct the phase difference according to the frequency offset information supplied from the frequency detection module.
